(19) United States
(12) Patent Application Publication
(10) Pub. No.: US 2010/0034567 A1
(43) Pub. Date: Feb. 11, 2010

(54) FIXING DEVICE AND IMAGE FORMING APPARATUS

(75) Inventors: Toshihiro SONE, Yokohama-shi (JP); Osamu TAKAGI, Chofu-shi (JP); Satoshi KINOUCHI, Shinjuku-ku (JP); Yoshinori TSUEDA, Fuji-shi (JP); Kazuhiko KIKUCHI, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/535,128

(22) Filed: Aug. 4, 2009

Related U.S. Application Data
(60) Provisional application No. 61/086,774, filed on Aug. 6, 2008.

(51) Int. Cl. G03G 15/20

(52) U.S. Cl. 399/328

(57) ABSTRACT

To provide a technique for reducing waste of thermal energy in a fixing device. The fixing device includes: a heating rotational unit configured to heat a sheet on which a toner image is formed; a pressing rotational unit configured to come into press contact with the heating rotational unit to form a nip between the heating rotational unit and the pressing rotational unit and nip and carry the sheet in cooperation with the heating rotational unit; a heating device configured to heat the heating rotational unit; and a heat accumulating unit configured to cover at least a range above at least one of the heating rotational unit and the pressing rotational unit.

### CROSS-REFERENCE TO RELATED APPLICATION

This application is based upon and claims the benefit of priority from: U.S. provisional application 61/086,774, filed on Aug. 6, 2008, the entire contents of each of which are incorporated herein by reference.

### TECHNICAL FIELD

The present invention relates to a fixing device for an image forming apparatus.

### BACKGROUND

In an image forming apparatus such as a multi function peripheral (MFP), as a device that heats and melts a toner deposited on a sheet and fixes the toner on the sheet, a fixing device including a fixing roller that heats and melts the toner and a pressing roller that comes into press contact with the fixing roller to nip and carry the sheet and compression-bonds the melted toner on the sheet is used. A fixing device of a fixing belt type that performs heating using, instead of the fixing roller, a fixing belt wound and suspended around a fixing roller and a tension roller is also used.

In the case of the fixing device of a roller type that performs fixing using the fixing roller and the pressing roller, the fixing roller is heated by a heating device provided on the inside or outside of the fixing roller. The toner can be fixed on the sheet by causing the sheet to pass through a fixing nip formed by the fixing roller and the pressing roller that comes into press contact with the fixing roller.

In such a fixing device, heat emitted from the fixing roller is accumulated in a heat equalizing roller. Specifically, when the fixing roller is heated, surface temperatures of the heat equalizing roller and the fixing roller are detected. When the surface temperature of the heat equalizing roller is higher than the surface temperature of the fixing roller, the heat equalizing roller is brought into press contact with the fixing roller and the fixing roller is efficiently heated using the heat accumulated in the heat equalizing roller. With such a device, warm-up time for the fixing roller can be reduced.

However, when such a configuration is adopted, in the fixing device, the heat equalizing roller needs to be separately provided besides the fixing roller (or the fixing belt) and the pressing roller. Further, a mechanism for separating the heat equalizing roller is also necessary. Therefore, a configuration of the fixing device is complicated. Only a very small part of the heat emitted from the fixing roller and the like can be accumulated by the heat equalizing roller alone that comes into press contact with the fixing roller. It is difficult to say that the heat of the fixing roller and the pressing roller can be effectively utilized.

### SUMMARY

It is an object of the present invention to provide a technique for reducing waste of thermal energy in the fixing device.

According to an aspect of the present invention, there is provided a fixing device including: a heating rotational unit configured to heat a sheet on which a toner image is formed; a pressing rotational unit configured to come into press contact with the heating rotational unit to form a nip between the heating rotational unit and the pressing rotational unit and nip and carry the sheet in cooperation with the heating rotational unit; a heating device configured to heat the heating rotational unit; and a heat accumulating unit configured to cover at least a range above at least one of the heating rotational unit and the pressing rotational unit.

### DESCRIPTION OF THE DRAWINGS

FIG. 1 is a sectional view of an image forming apparatus according to a first embodiment of the present invention;

FIG. 2 is a perspective view of a fixing device according to the first embodiment;

FIG. 3 is a sectional view of the fixing device according to the first embodiment;

FIG. 4 is an enlarged view of the vicinity of a pressing roller of the fixing device shown in FIG. 3;

FIG. 5 is a sectional view of a fixing device according to a second embodiment of the present invention;

FIG. 6 is a functional block diagram for explaining an image forming apparatus including the fixing device according to the second embodiment;

FIG. 7 is a sectional view of a state in which a pressing roller of a fixing device according to a third embodiment of the present invention is in press contact with a fixing belt;

FIG. 8 is a sectional view of a state in which the pressing roller shown in FIG. 7 is separated from the fixing belt;

FIG. 9 is a functional block diagram for explaining an image forming apparatus including the fixing device according to the third embodiment;

FIG. 10 is a sectional view of a fixing device according to a fourth embodiment of the present invention; and

FIG. 11 is a functional block diagram for explaining an image forming apparatus including the fixing device according to the fourth embodiment.

### DETAILED DESCRIPTION

Embodiments of the present invention are explained below with reference to the accompanying drawings.

### First Embodiment

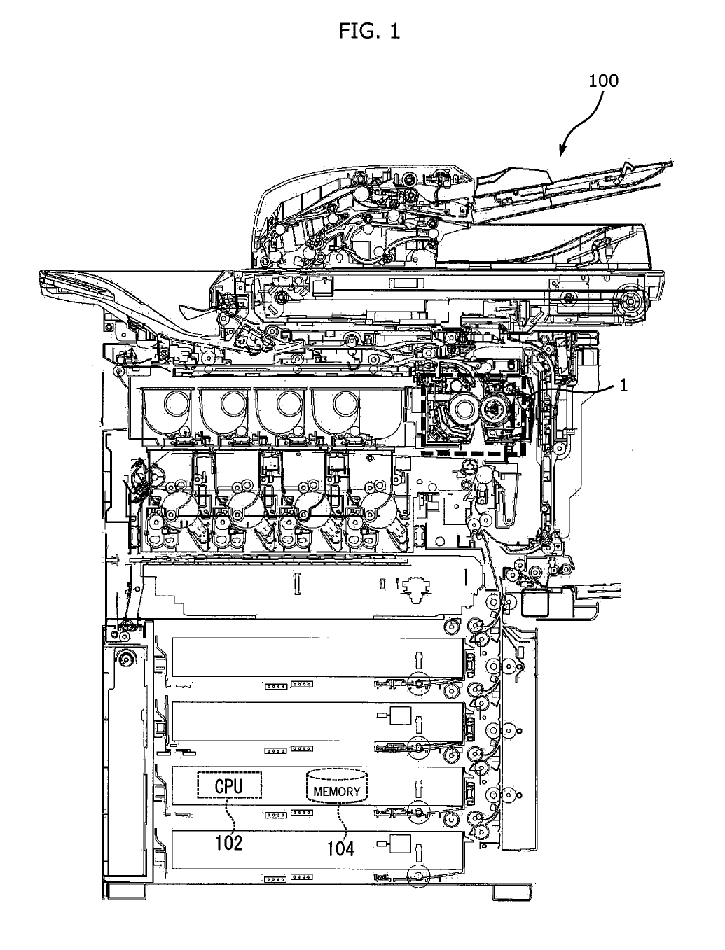

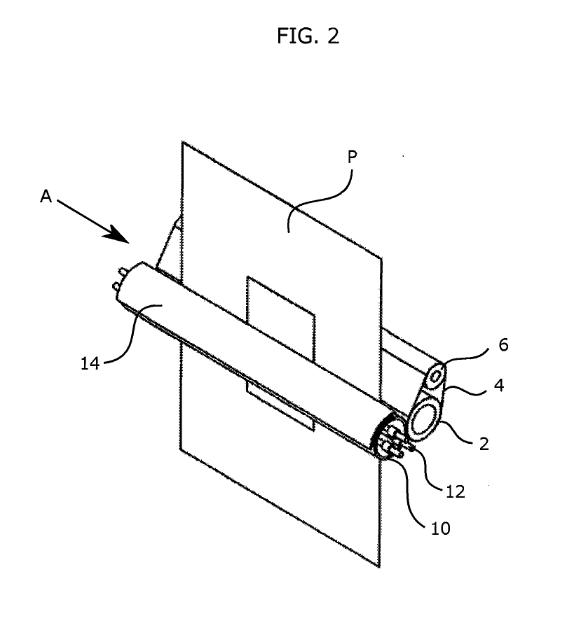

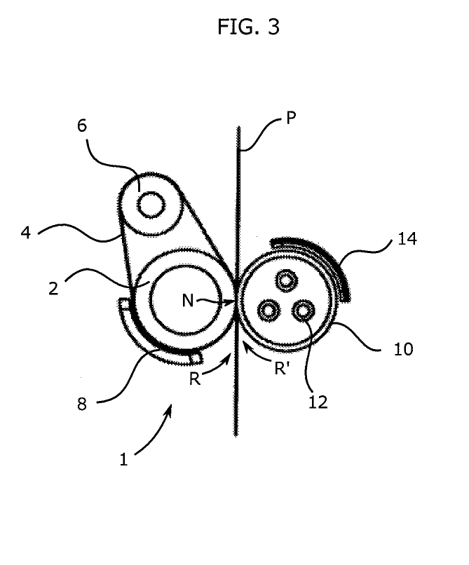

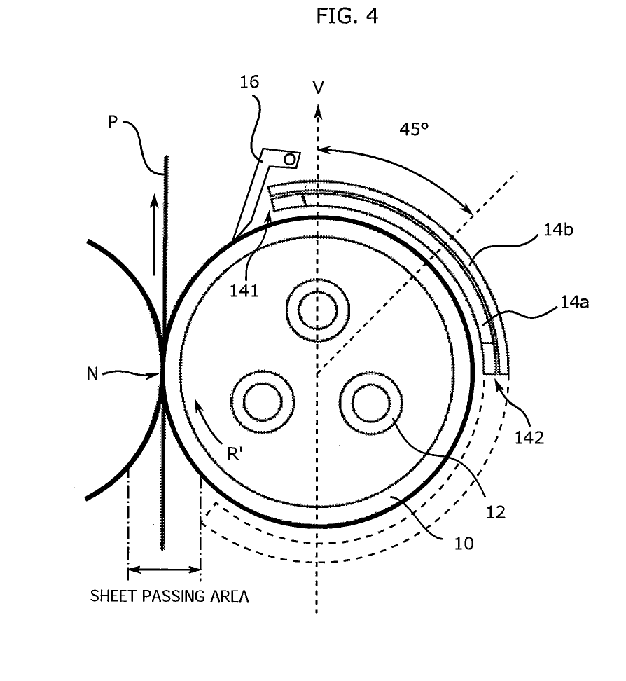

FIG. 1 is a sectional view of an image forming apparatus 100 according to a first embodiment of the present invention. FIG. 2 is a perspective view of a fixing device 1 of the image forming apparatus 100 for explaining a configuration of the fixing device 1. FIG. 3 is a sectional view of a fixing device 1 viewed from an arrow A direction shown in FIG. 2. FIG. 4 is an enlarged view of the vicinity of a pressing roller 10 shown in FIG. 3.

The image forming apparatus 100 shown in FIG. 1 includes the fixing device 1 according to this embodiment arranged in a section surrounded by a dotted line in FIG. 1, a CPU 102, and a memory 104. The fixing device 1 includes a heating rotational unit, a pressing roller 10 as a pressing rotational unit, an induction heating coil 8 as a heating device, a heating lamp 12 as a pressing-roller heating unit, a heat accumulating unit 14, and a peeling pawl 16. The heating rotational unit according to this embodiment includes a fixing roller 2, a tension roller 6, and a fixing belt 4 wound and suspended around the fixing roller 2 and the tension roller 6. In the fixing device 1, a nip N is formed by the fixing belt 4 that is rotated in a direction of an arrow R by the fixing roller 2 driven to rotate by a not-shown driving motor and the pressing roller 10 that is arranged to be opposed to the fixing roller 2 via the fixing belt 4 and comes into press contact with the fixing belt 4. The fixing belt 4 and the pressing roller 10, which comes into contact with the fixing belt 4, nip and carry a sheet P such as paper or an OHP sheet in cooperation with each other. Consequently, a toner is heated and melted in the nip N and an image can be fixed on the sheet P.

The components of the fixing device 1 according to this embodiment are explained below.

First, the components of the heating rotational unit are explained.

The fixing roller 2 is a roller that heats the fixing belt 4 that heats a sheet in the nip N. A conductive layer of the fixing roller 2 generates heat according to a change in a magnetic flux generated by the induction heating coil 8. The fixing roller 2 heats, with the heat, the fixing belt 4 to temperature necessary for fixing. The fixing roller 2 includes a cored bar and an elastic layer as conductive layers.

The fixing belt 4 is an endless belt wound and suspended around the fixing roller 2 and the tension roller 6. The fixing belt 4 is rotated in the arrow R direction by the fixing roller 2 driven by the not-shown driving motor. The fixing belt 4 is heated by the heat of the fixing roller 2 heated by the induction heating coil 8. The fixing belt 4 can heat and melt, with the heat of the fixing belt 4, the toner on the sheet P passing through the nip N.

As explained above, the fixing belt 4 is wound and suspended around the tension roller 6. The tension roller 6 is a roller that applies fixed tension to the fixing belt 4 in cooperation with the fixing roller 2. For example, the tension roller 6 is urged in an opposite direction of a direction opposed to the fixing roller 2 by an elastic member such as a coil spring or a leaf spring. The tension roller 6 applies the fixed tension to the fixing belt 4.

The induction heating coil 8 is an induction heating device that heats the fixing roller 2. The induction heating coil 8 is arranged below the fixing roller 2 to be opposed to the outer circumferential surface of the fixing roller 2. When a high-frequency alternating current is applied to the induction heating coil 8 from a not-shown energizing circuit, the induction heating coil 8 generates a magnetic flux and generates, with the magnetic flux, an eddy-current in the cored bar (or a separately provided conductive layer) of the fixing roller 2. The cored bar (or the conductive layer) in which the eddy-current is generated generates heat with electric resistance thereof. The entire fixing roller 2 is heated by the heat. The fixing roller 2 can heat the fixing belt 4 with the heat of the fixing roller 2.

A configuration of the pressing rotational unit is explained.

As explained above, the pressing roller 10 is in press contact with the fixing belt 4 by a not-shown pressing mechanism to form the nip N in which fixed nip width is kept. The pressing roller 10 nips and carries the sheet P in cooperation with a belt surface of the fixing belt 4. With pressure of the pressing roller 10 against the fixing belt 4 and the fixing roller 2, the toner on the sheet P heated and melted by the fixing belt 4 is compression-bonded to the sheet P. The pressing roller 10 is coated with silicone rubber, fluorine rubber, or the like as an elastic layer around the cored bar.

As shown in FIG. 4, a peeling pawl 16 is provided on a downstream side in a rotating direction R′ from the nip N of the pressing roller 10. The peeling pawl 16 is a member that peels off, when the sheet P nipped and carried by the fixing belt 4 and the pressing roller 10 adheres to the pressing roller 10, the sheet P from the surface of the pressing roller 10. The peeling pawl 16 comes into contact with the surface of the pressing roller 10 with a low load.

The pressing roller 10 according to this embodiment is heated by the heating lamp 12. When the fixing device 1 is warmed up, the pressing roller 10 is heated by the heating lamp 12. Therefore, it is possible to perform pressing at the temperature necessary for fixing without lowering the temperature of the fixing belt 4 in the fixing. The heating lamp 12 is arranged on the inside of the pressing roller 10 in parallel to an axial direction of the pressing roller 10. Usually, the heating lamp 12 is turned on in warm-up and fixing processing to heat the pressing roller 10 to temperature necessary for the fixing processing. The heating lamp 12 is turned off in a standby state in which the fixing processing is not performed.

The heat accumulating unit 14 is a member that covers, in an arcuate shape, the vicinity above the pressing roller 10 along the outer circumferential surface of the roller, accumulates heat emitted from the pressing roller 10, and keeps the pressing roller 10 warm with the heat. As explained above, the pressing roller 10 is heated from the inside by the heating lamp 12. The heat of the pressing roller 10 is radiated to the surroundings. Therefore, usually, the radiated heat warms the ambient air and disperses to the outside. However, when the heat accumulating unit 14 is provided at least in the section above the outer circumference of the pressing roller 10 in this way, it is possible to accumulate the heat emitted from the pressing roller 10, keep the pressing roller 10 warm, and improve thermal efficiency in the pressing roller 10. The heat accumulating unit 14 is desirably arranged at a distance of 1.8 mm to 8.0 mm from the outer surface of the pressing roller 10. This is because, if the heat accumulating unit 14 is apart from the outer surface by more than 8.0 mm, the heat tends to escape.

The heat accumulating unit 14 according to this embodiment includes a heat accumulating layer 14a and a heat insulating layer 14b.

The heat accumulating layer 14a is a layer that absorbs the heat emitted from the pressing roller 10 and accumulates the heat. The heat accumulating layer 14a according to this embodiment is formed of aluminum sheet metal. The heat accumulating layer 14a is desirably thick in order to increase a heat capacity and improve a heat accumulating effect. As the heat accumulating layer 14a, besides the aluminum sheet metal, metal plates such as a zinc steel plate, stainless steel sheet metal, and a copper plate can be used.

The heat insulating layer 14b is a layer that is formed on the outer side in the radial direction of the heat accumulating layer 14a and keeps the heat accumulated by the heat accumulating layer 14a not to escape to the outside of the heat accumulating unit 14. The heat insulating layer 14b according to this embodiment is formed by silicone rubber. As the heat insulating layer 14b, besides the silicone rubber, materials having a high heat keeping effect such as silicone foam rubber, carbon resin, polycarbonate, and a heat keeping sheet material made of extra fine fiber can be used.

In this embodiment, a heat capacity ratio in unit area of the heat accumulating layer 14a and the heat insulating layer 14b is desirably equal to or larger than 400 (zinc):0.07 (silicone).

A ratio of thermal conductivities of the heat accumulating layer 14a and the heat insulating layer 14b is desirably equal to or larger 73 (iron):0.16 (polyimide resin)

A specific heat capacity per unit area of the heat accumulating layer 14a is desirably equal to or larger than 400 J/(kg·K).

Infrared ray emissivity of the outer circumferential surface of the heat insulating layer 14b is desirably equal to or smaller than 0.2.

A range in which the heat accumulating unit 14 according to this embodiment covers the pressing roller 10 is specifically explained.

In the axial direction of the pressing roller 10, the heat accumulating unit 14 covers at least a range larger than a range in the axial direction heated by the heating lamp 12. This is because the heat mainly disperses from a heated section. Desirably, the heat accumulating unit 14 covers an entire area from one end to the other end in the axial direction of the pressing roller 10 as shown in FIG. 2. The heat accumulating unit 14 can more surely absorb the heat by covering the entire axial direction of the pressing roller 10.

A range in which the heat accumulating unit 14 covers the circumferential direction of the pressing roller 10 is explained. As shown in FIGS. 2 to 4, the heat accumulating unit 14 according to this embodiment is formed in an arcuate shape along the outer circumference on the upper side of the pressing roller 10. The heat accumulating unit 14 is formed to cover at least a range from a position in a vertical direction V passing through the rotation center of the pressing roller 10 in FIG. 4 to a position of a central angle of 45 degrees on a side opposite to the nip N with respect to the vertical direction V.

The position of an end 141 on the nip N side (i.e., a range further on the nip N side than the vertical direction V covered by the heat accumulating unit 14) is desirably a position further on the downstream side in the rotating direction R′ than a contact position of the peeling pawl 16 and the pressing roller 10. This is for the purpose of covering as wide a range as possible on the nip N side from the vertical direction V above the pressing roller 10 without interfering with the operation of the peeling pawl 16. This makes it possible to sufficiently accumulate heat emitted in the range on the nip N side from the vertical direction V without damaging the function of the peeling pawl 16. It is undesirable to extend the heat accumulating unit 14 to the nip N side to climb over the peeling pawl 16. This is because it is likely that a sheet peeled by the peeling pawl 16 comes into contact with the heat accumulating unit 14 again to cause a sheet jam.

The position of an end 142 on the opposite side of the nip N is explained. As explained above, the position of the end 142 is the position at least at 45 degrees with respect to the vertical direction V. The position can be, at the maximum, a position reaching a passing area of the sheet P (a range indicated by an alternate long and short dash line in FIG. 4) below the nip N passing below the pressing roller 10 (see a section indicated by a broken line in FIG. 4). The position of the end 142 is the position at least at 45 degrees because a range in which thermal convection is caused by the heat emitted from the pressing roller 10 is mainly a range above 45 degrees with respect to the vertical direction V. Specifically, when a range in which the heat accumulating unit 14 covers the pressing roller 10 is a range narrower than 45 degrees with respect to the vertical direction V, a heat value that escapes without being accumulated in the heat accumulating unit 14 increases and the heat keeping effect is not sufficiently obtained. The position of the end 142 may be any position in a range up to the passing area of the sheet P on the lower side as long as the position is equal to or larger than 45 degrees with respect to the vertical direction V. If the range for covering the pressing roller 10 increases, the heat keeping effect is improved. However, it is undesirable that the position of the end 142 enters the passing area of the sheet P. This is because the sheet P is in contact with the end 142 and a sheet jam is caused.

It is generally known that a heat value emitted upward from a heated roller is particularly large in a range at a tilt angle smaller than 45 degrees with respect to the vertical direction passing through the center of the roller. In other words, since the roller heated in the range at least at 45 degrees from the vertical direction is covered, the emitted heat can be collected.

The heat accumulating unit 14 according to this embodiment shown in FIGS. 2 to 4 covers a range from a position where the peeling pawl 16 is arranged to a position at about 90 degrees with respect to the vertical direction V (a horizontal position), i.e., a range of about a quarter of the outer circumferential surface of the pressing roller.

As another component included in the image forming apparatus 100, the CPU 102 controls image formation processing in the image forming apparatus 100.

The memory 104 stores a computer program used for the image formation processing in the image forming apparatus 100. The memory 104 can include a RAM (Random Access Memory), a ROM (Read Only Memory), a DRAM (Dynamic Random Access Memory), a SRAM (Static Random Access Memory), or a VRAM (Video RAM).

With the fixing device 1 including the heat accumulating unit 14 explained above, the heat accumulating unit 14 can absorb and accumulate the heat emitted from the pressing roller 10 and keep the pressing roller 10 warm. Since the heat accumulating unit 14 includes the heat insulating layer 14b, the heat accumulated in the heat accumulating layer 14a does not escape to the outside. Therefore, an excellent heat keeping effect can be obtained. With such a heat keeping effect, even if the heating lamp 12 is turned off in the standby state of the fixing device 1, a temperature fall less easily occurs. Therefore, the fixing device 1 according to this embodiment can be rapidly reset to the temperature necessary for the fixing processing from the standby state and can reduce warm-up time.

Since a temperature fall less easily occurs and the warm-up time is reduced, energy for heating by the heating lamp 12 can be reduced and energy saving can be realized.

As a specific example demonstrating the heat keeping effect, when the pressing roller 10 was heated by the heating lamp 12 and, after the pressing roller 10 was left untouched for one hour, an experiment for measuring surface temperature of the pressing roller 10 was performed, a result obtained by the experiment indicated that the pressing roller 10 including the heat accumulating unit 14 had the surface temperature about 7° C. higher than that of a pressing roller not including the heat accumulating unit 14. As it is seen from this result, when the heat accumulating unit 14 according to this embodiment is included, it is possible to obtain effects such as prevention of a temperature fall of the pressing roller 10, quick reset to the temperature necessary for the fixing, and energy saving.

In the above explanation, the heat accumulating unit 14 according to this embodiment is formed in the arcuate shape along the outer circumference of the pressing roller 10. However, the shape of the heat accumulating unit 14 is not limited to this. For example, the heat accumulating unit 14 may be formed in a polygonal shape along the outer circumferential surface of the pressing roller 10.

In the above explanation, the heat accumulating unit 14 according to this embodiment includes the single member. However, a configuration of the heat accumulating unit 14 is not limited to this. The same effects can be obtained when the heat accumulating unit 14 covers the pressing roller 10 along the outer circumference thereof with plural heat accumulating members.

### Second Embodiment

The fixing device 1 according to a second embodiment of the present invention is explained. This embodiment is different from the first embodiment in that the heat accumulating unit 14 explained in the first embodiment can move along the outer circumference of the pressing roller 10 and cover a wider range above the pressing roller 10. In the following explanation of this embodiment, explanation of the same components as those in the first embodiment is omitted.

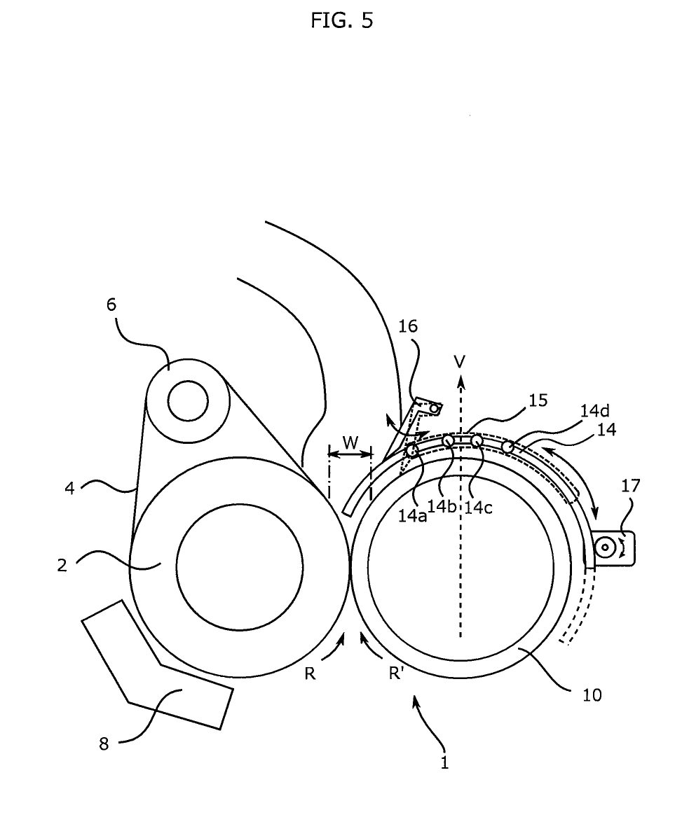

FIG. 5 is a sectional view of the pressing roller 10 of the fixing device 1 according to the second embodiment. FIG. 5 is a diagram of a state in which the heat accumulating unit 14 moves from a first position where the end 141 is retracted to a position further on the downstream side in the rotating direction R′ with respect to the nip N than the peeling pawl 16 as shown in FIG. 4 to a second position where a section on the end 141 side of the heat accumulating unit 14 enters a passing area W of the sheet P and blocks a part of the passing area W of the sheet P.

To allow the heat accumulating unit 14 to move along the outer circumference of the pressing roller 10 from the first position to the second position, the fixing device 1 according to this embodiment further includes cams 15, cam followers 14a to 14d formed in the heat accumulating unit 14 that follow the cams 15, and a heat-accumulating-unit driving motor 17 as a driving unit that moves the heat accumulating unit 14.

The cams 15 are formed on outer sides at both the ends of the heat accumulating unit 14 in the axial direction of the pressing roller 10. The cams 15 are formed in a shape along the outer circumference of the pressing roller 10.

As explained above, the cam followers 14a to 14d are arranged at both the ends of the heat accumulating unit 14 in the axial direction of the pressing roller 10.

A track of movement of the heat accumulating unit 14 along the circumference of the pressing roller 10 is defined by the cams 15 and the cam followers 14a to 14d. When the cam followers 14a to 14d attached to both the ends of the heat accumulating unit 14 follow the cams 15, the heat accumulating unit 14 can move along the circumference of the pressing roller 10.

The heat-accumulating-unit driving motor 17 is a member for moving the heat accumulating unit 14. The heat-accumulating-unit driving motor 17 engages with the heat accumulating unit 14. When the heat-accumulating-unit driving motor 17 is driven to rotate by the control by a heat-accumulating-unit-driving-motor control unit explained below, the heat-accumulating-unit driving motor 17 can move the heat accumulating unit 14 along the cams 15. As the heat-accumulating-unit driving motor 17, to allow the heat accumulating unit 14 to move in a predetermined range from the first position to the second position, for example, a positioning-controllable stepping motor can be used. It is also possible to arrange a sensor that detects the position of the heat accumulating unit 14 and drive the heat-accumulating-unit driving motor 17 on the basis of a detection signal of the sensor.

With the configuration explained above, the heat accumulating unit 14 according to this embodiment can move in the predetermined range between the first position and the second position around the pressing roller 10 and perform heat accumulation in different positions when a sheet passes and when a sheet does not pass. Specifically, in a state in which the fixing device 1 is performing the fixing processing, the heat accumulating unit 14 retracts to the first position where passage of the sheet P is not prevented and performs heat accumulation. On the other hand, in a state in which the fixing device 1 does not perform the fixing processing, i.e., in a state in which a sheet does not pass through the fixing device 1, the heat accumulating unit 14 is driven by the heat-accumulating-unit driving motor 17 and can move to the second position shown in FIG. 5 along the cams 15 and perform heat accumulation.

When the heat accumulating unit 14 performs heat accumulation in the second position, if the heat accumulating unit 14 has a shape for covering 90 degrees or more around the pressing roller 10, the heat accumulating unit 14 can cover a range above the pressing roller 10 equal to or larger than 45 degrees on both the sides, i.e., the nip N side and the opposite side, with the vertical direction V as a boundary. Therefore, there is an effect that a heat accumulation effect is higher compared with that obtained when the heat accumulating unit 14 covers the pressing roller 10 in the first position. On the other hand, when the heat accumulating unit 14 does not move in the manner explained in the first embodiment or when the heat accumulating unit 14 performs heat accumulation in the first position, the heat accumulating unit 14 can cover only up to the position of the peeling pawl 16 in the range on the nip N side with respect to the vertical direction. Therefore, the heat accumulating unit 14 cannot absorb heat emitted from a range further on the nip N side than the position of the peeling pawl 16.

When the heat accumulating unit 14 is moved to the second position for blocking the sheet passing area, the heat accumulating unit 14 can be moved by springing up the peeling pawl 16. It goes without saying that the heat accumulating unit 14 can be moved by separately providing a driving motor or the like that moves the peeling pawl 16 up and down. It is also possible to move the peeling pawl 16 in association with the movement of the heat accumulating unit 14.

As another component, the CPU 102 according to this embodiment further performs driving control for the heat accumulating unit 14. The memory 104 stores a computer program for executing the image formation processing including a computer program for performing the driving control for the heat accumulating unit 14.

In the explanation of this embodiment, the heat accumulating unit 14 includes the four cam followers 14a to 14d. However, the number of cam followers is not limited. The number of cam followers may be any number as long as the heat accumulating unit 14 can accurately follow the cams 15.

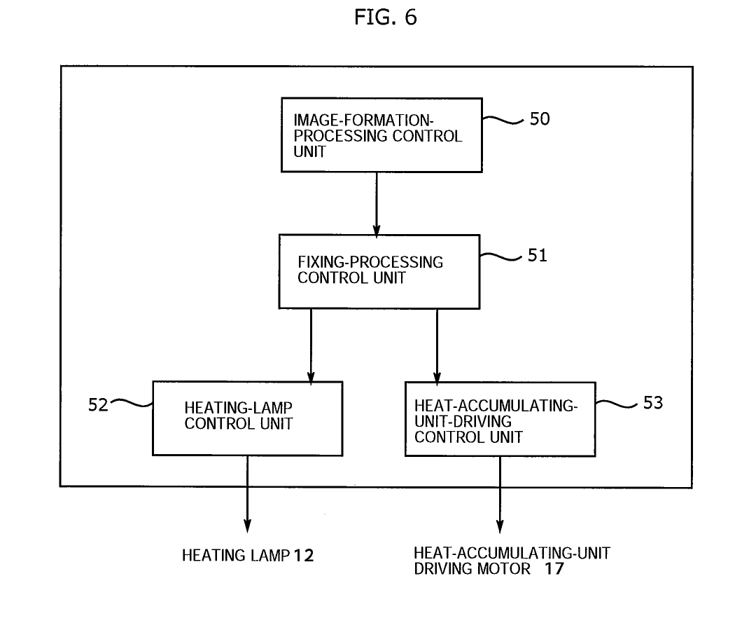

Processing for moving the heat accumulating unit 14 is explained with reference to FIG. 6. FIG. 6 is a functional block diagram for explaining the image forming apparatus 100 including the fixing device 1 according to this embodiment. The image forming apparatus 100 according to this embodiment includes an image-formation-processing control unit 50, a fixing-processing control unit 51, a heating-lamp control unit 52, and a heat-accumulating-unit-driving control unit 53.

The image-formation-processing control unit 50 controls image processing of the entire image forming apparatus 100 according to this embodiment.

The fixing-processing control unit 51 controls the fixing processing by the fixing device 1.

The heating-lamp control unit 52 receives an instruction from the fixing-processing control unit 51 and controls processing for turning on and off the heating lamp 12 and heating the pressing roller 10 to the temperature necessary for the fixing processing.

The heat-accumulating-unit-driving control unit 53 receives an instruction from the fixing-processing control unit 51, controls to drive the heat-accumulating-unit driving motor 17, and performs processing for moving the heat accumulating unit 14 along the circumference of the pressing roller 10.

In the functional blocks explained above, first, when the fixing-processing control unit 51 receives, from the image-formation-processing control unit 50, an instruction for staying in the standby state without performing the fixing processing, the fixing-processing control unit 51 issues an instruction for turning off the heating lamp 12 to the heating-lamp control unit 52. The fixing-processing control unit 51 issues an instruction for driving the heat-accumulating-unit driving motor 17 to the heat-accumulating-unit-driving control unit 53. The heat-accumulating-unit-driving control unit 53 drives the heat-accumulating-unit driving motor 17 to move the heat accumulating unit 14 from the first position as a retracted position in the fixing processing performing state to the second position shown in FIG. 5. With such control, when the fixing device 1 comes into the standby state, it is possible to move the heat accumulating unit 14, accumulate heat emitted from the pressing roller 10 in a position where the heat can be absorbed more, and keep the pressing roller 10 warm.

When the fixing device 1 shifts from the standby state to a state in which the image formation is performed in the image forming apparatus 100, the fixing-processing control unit 51 receives an instruction for performing the fixing processing from the image-formation-processing control unit 50 and releases the standby state. Specifically, the fixing-processing control unit 51 instructs the heating-lamp control unit 52 to turn on the heating lamp 12 and performs warm-up of the pressing roller 10. The fixing-processing control unit 51 instructs the heat-accumulating-unit-driving control unit 53 to drive the heat-accumulating-unit driving motor 17 and retract the heat accumulating unit 14 to the first position. The heat-accumulating-unit-driving control unit 53 receives this instruction, drives the heat-accumulating-unit driving motor 17, and moves the heat accumulating unit 14 to the first position.

When the heat-accumulating-unit driving motor 17 is a positioning-controllable motor such as a stepping motor, the heat-accumulating-unit-driving control unit 53 can move the heat accumulating unit 14 to a predetermined position by driving the heat-accumulating-unit driving motor 17 by a distance from the first position to the second position stored in the memory 104 in advance. When a position detecting sensor or the like is separately provided to move the heat accumulating unit 14 on the basis of a detection signal, the heat-accumulating-unit-driving control unit 53 can move the heat accumulating unit 14 to the predetermined position by performing control for stopping the heat-accumulating-unit driving motor 17 when the heat-accumulating-unit-driving control unit 53 receives a signal indicating that the heat accumulating unit 14 reaches the first position or a signal indicating that the heat accumulating unit 14 reaches the second position.

The functions and the operation explained above are realized by causing the CPU 102 to execute the computer program for performing the image formation processing stored in the memory 104.

As explained above, with the fixing device 1 according to this embodiment, when the fixing processing is performed and a sheet passes through the fixing device 1, the heat accumulating unit 14 accumulates the heat from the pressing roller 10 in the first position further on the downstream side in the rotating direction R′ than the peeling pawl 16 and keeps the pressing roller 10 warm. On the other hand, in a state in which the fixing processing is not performed, the heat accumulating unit 14 can move to the second position where the distal end of the heat accumulating unit 14 blocks a part of the passing area of the sheet P and accumulate and keep heat. Therefore, since a wider range in a range in which thermal convection occurs can be covered in the standby state, there is an effect that heat accumulation can be efficiently performed and the heat keeping effect is high. Therefore, it is possible to more effectively prevent a temperature fall of the pressing roller 10 in the standby state. It is possible to reduce energy necessary for performing the fixing processing and enable quicker reset to the fixing temperature.

### Third Embodiment

The fixing device 1 according to a third embodiment of the present invention is explained. The third embodiment is different from the second embodiment in that, in the standby state in which the fixing device 1 does not perform the fixing processing, the pressing roller 10 separates from the fixing belt 4 of the heating rotational unit. The fixing device 1 according to the third embodiment is explained below. Explanation of the same components as those in the first and second embodiments is omitted.

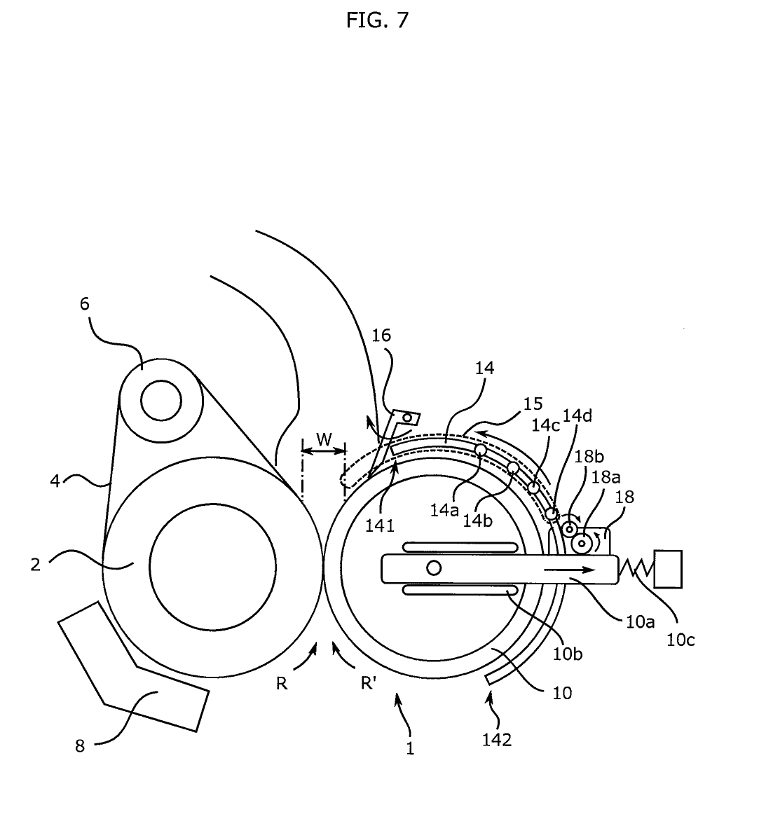

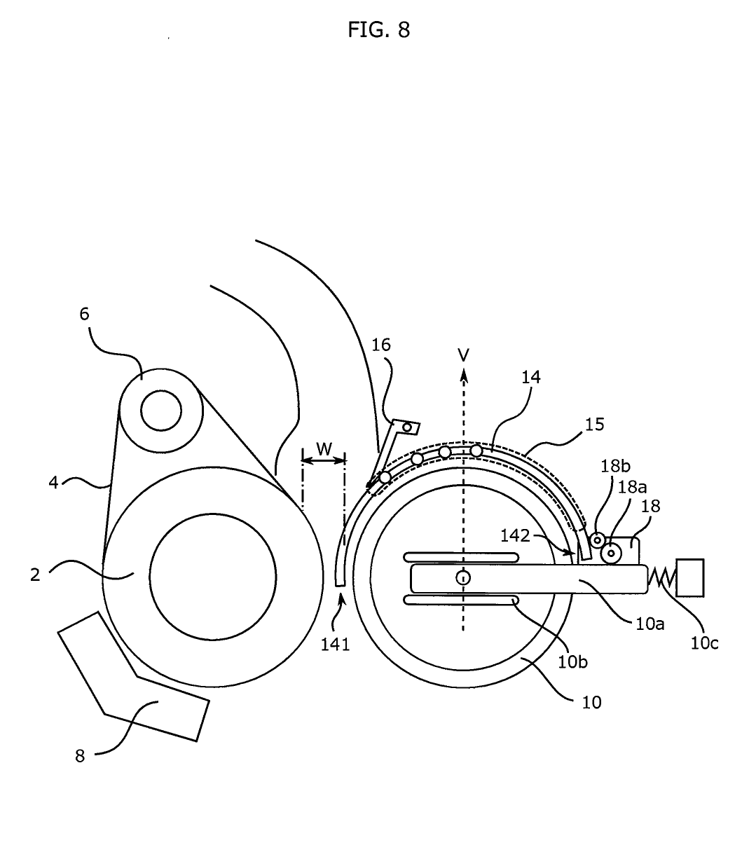

FIG. 7 is a sectional view of a state in which the pressing roller 10 of the fixing device 1 according to the third embodiment is in press contact with the fixing belt 4. FIG. 8 is a sectional view of a state in which the pressing roller 10 is separated from the fixing belt 4.

The fixing device 1 according to this embodiment further includes a separation driving unit 18 in addition to the fixing roller 2, the fixing belt 4, the tension roller 6, the heating coil 8, the pressing roller 10, the heating lamp 12, and the heat accumulating unit 14. The separation driving unit 18 includes a first gear 18a that engages with an arm 10a that pivotally supports the pressing roller 10 and a second gear 18b as an interlocking unit that engages with the heat accumulating unit 14.

The separation driving unit 18 separates the pressing roller 10, which is set in press contact with the fixing belt 4 by a pressing spring 10c as a pressing mechanism, from the fixing belt 4. Specifically, the first gear 18a of the separation driving unit 18 rotates according to the driving of the separation driving unit 18 to thereby move the arm 10a, which pivotally supports the pressing roller 10, in a direction away from the fixing belt 4 along a guide 10b. Then, the arm 10a moves against the force of the pressing spring 10c. The pressing roller 10 separates from the fixing belt 4. Such separating action for the pressing roller 10 by the separation driving unit 18 is performed in the standby state in which the fixing device 1 does not perform the fixing processing.

As the separation driving unit 18, a positioning-controllable driving member such as a stepping motor can be used or a sensor such as a position detecting sensor and a motor can be used in combination.

The heat accumulating unit 14 according to this embodiment moves, in association with the separating action of the pressing roller 10, from the first position (see FIG. 7) in the state in which the fixing processing is performed to the second position in the state in which the fixing processing is not performed. Specifically, in the heat accumulating unit 14, when the first gear 18a rotates according to the driving of the separation driving unit 18, the second gear 18b meshing with the first gear 18a rotates. Since the second gear 18b meshes with the heat accumulating unit 14, the heat accumulating unit 14 moves to the nip N side along the circumference of the pressing roller 10 according to the rotation of the second gear 18b. With such a mechanism, the end 141 of the heat accumulating unit 14 enters the passing area of the sheet P in association with the separating action of the pressing roller 10 separating from the fixing belt 4. The heat accumulating unit 14 can move to the second position for blocking the passing area of the sheet P and accumulates and keeps the heat of the pressing roller 10.

Further, in this embodiment, since the pressing roller 10 and the fixing belt 4 are separated from each other, the heat accumulating unit 14 can be moved to a position beyond the position where the nip N is formed. Therefore, in this embodiment, the second position of the heat accumulating unit 14 can be set in a position as deep as a position between the pressing roller 10 and the fixing belt 4 as shown in FIG. 8. Since the heat accumulating unit 14 can cover a range up to the position between the pressing roller 10 and the fixing belt 4, in the standby state, the heat accumulating unit 14 can cover any range around the pressing roller 10. Therefore, for example, when the heat accumulating unit 14 is formed to cover 180 degrees around the pressing roller 10, if the heat accumulating unit 14 moves to the second position in the standby state, the heat accumulating unit 14 can cover an upper half of the pressing roller 10. Therefore, a higher heat accumulation effect and a higher heat keeping effect can be obtained.

Like the heat accumulating unit 14 according to the second embodiment, the heat accumulating unit 14 according to this embodiment includes the cams 15 and the cam followers 14a to 14d and can move around the pressing roller 10. However, in this embodiment, unlike the second embodiment, the heat accumulating unit 14 is not directly driven and operates in association with the separation operation. Therefore, to move the heat accumulating unit 14 to the first position and the second position, diameters and the number of gears, the position of the heat accumulating unit 14, and the like are set to locate the heat accumulating unit 14 in the first position in a state in which the pressing roller 10 is in press contact with the fixing belt 4 and locate the heat accumulating unit 14 in the second position in a state in which the pressing roller 10 is separated from the fixing belt 4.

In this embodiment, in the second position of the heat accumulating unit 14, when the heat accumulating unit 14 moves to the position where the nip N of the pressing roller 10 is formed, the heat accumulating unit 14 needs to be formed such that the end 142 on the opposite side of the nip N with respect to the vertical direction V is in a position at an angle equal to or larger than 45 degrees with respect to the vertical direction V in a state in which the heat accumulating unit 14 moves to the second position. As explained in the first embodiment, convection due to heat emitted from a heated roller mainly occurs in a range of 45 degrees from the vertical direction. Therefore, when a range in which the heat accumulating unit 14 covers the opposite side of the nip N with respect to the vertical direction V is smaller than 45 degrees due to the movement of the heat accumulating unit 14, the heat emitted from the pressing roller 10 cannot be sufficiently accumulated.

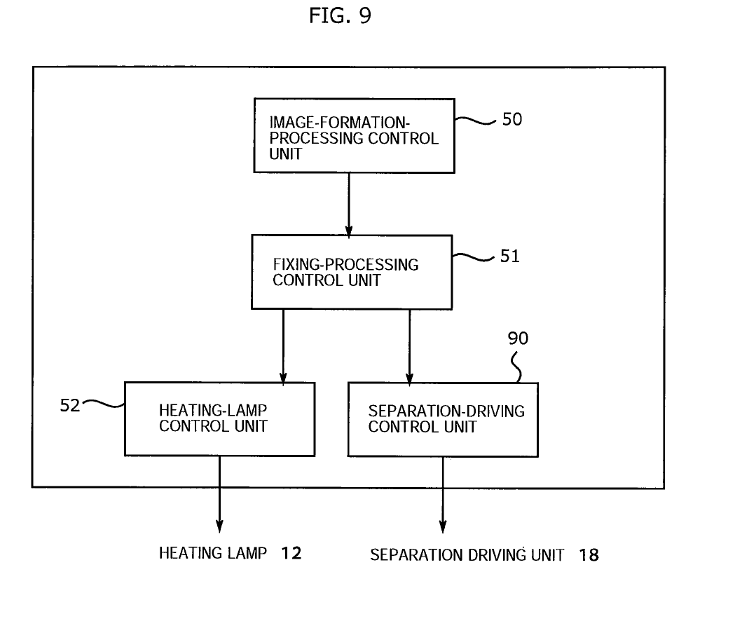

Processing of the separating action of the fixing device 1 is explained with reference to FIG. 9. FIG. 9 is a functional block diagram for explaining the image forming apparatus 100 including the fixing device 1 according to this embodiment.

The image-formation-processing control unit 50, the fixing-processing control unit 51, and the heating-lamp control unit 52 are the same as the functional blocks explained with reference to FIG. 6 in the second embodiment. Therefore, explanation of the units is omitted. A separation-driving control unit 90 controls the pressing roller 10 to separate from the fixing belt 4 according to the driving of the separation driving unit 18.

In the functional blocks, first, when the fixing device 1 receives an instruction from the image-formation-processing control unit 50 and comes into the standby state, the separation-driving control unit 90 receives, from the fixing-processing control unit 51, an instruction for separating the pressing roller 10 from the fixing belt 4. The separation-driving control unit 90 drives the separation driving unit 18 on the basis of the instruction, releases the press contact of the pressing roller 10 with the fixing belt 4, and moves the pressing roller 10 until the pressing roller 10 separates from the fixing belt 4 by a predetermined distance. The heat accumulating unit 14 moves, according to the driving of the separation driving unit 18, from the first position to the second position in association with the separating action. The operation for the separation of the pressing roller 10 and the movement of the heat accumulating unit 14 is completed.

On the other hand, when the fixing device 1 shifts from the standby state to the state in which the fixing processing is performed, to bring the pressing roller 10 into press contact with the fixing belt 4, the fixing-processing control unit 51 instructs the separation-driving control unit 90 to move the pressing roller 10 in the direction of the fixing belt 4. The separation-driving control unit 90 drives the separation driving unit 18 on the basis of the instruction to move the pressing roller 10 to a position where the pressing roller 10 comes into press contact with the fixing belt 4 at predetermined pressure. In association with the press contact operation, the heat accumulating unit 14 retracts to the first position further on the downstream side in the rotating direction R′ than the peeling pawl 16. According to the processing explained above, it is possible to move the heat accumulating unit 14 along the circumference of the pressing roller 10 in association with the separating action of the pressing roller 10 and accumulate and keep heat in an optimum position.

With the fixing device 1 according to this embodiment, when the pressing roller 10 separates from the fixing belt 4 in the standby state, the heat accumulating unit 14 can move in association with the separating action and cover the pressing roller 10 up to the position where the pressing roller 10 and the fixing belt 4 forms the nip N. Therefore, in the standby state, a wider range around the pressing roller 10 can be covered by the heat accumulating unit 14 and a temperature fall of the roller can be more effectively suppressed. Therefore, in the fixing device 1 of the type for separating the pressing roller 10 and the fixing belt 4 in the standby state, as in the fixing device 1 according to the embodiments explained above, it is possible to reduce energy necessary for performing the fixing processing and enable quicker reset to the fixing temperature.

In the explanation of this embodiment, the heat accumulating unit 14 moves in association with the separating action of the pressing roller 10 However, the movement of the heat accumulating unit 14 is not limited to this. It is also possible to separately provide a driving member that moves the heat accumulating unit 14 and move the heat accumulating unit 14 independently from the separating action.

In the explanation of this embodiment, the pressing roller 10 separates from the fixing belt 4. However, the separation of the pressing roller 10 and the fixing belt 4 is not limited to this. The heating rotational unit such as the fixing belt 4 may separate from the pressing roller 10 or the fixing belt 4 and the pressing roller 10 may separate from each other.

### Fourth Embodiment

A fourth embodiment of the present invention is explained. The fourth embodiment is different from the other embodiments in that the fixing device 1 includes, in addition to the arcuate heat accumulating unit 14 that covers the outer circumference of the pressing roller 10, an opening and closing heat accumulating unit 20 that comes into contact with a carrying guide surface G1 formed on the fixing belt 4 side above the nip N, blocks a sheet carrying path, and performs heat accumulation in a state in which the fixing processing is not performed. The fixing device 1 according to this embodiment is explained below. Explanation of the same components as those in the embodiments explained above is omitted.

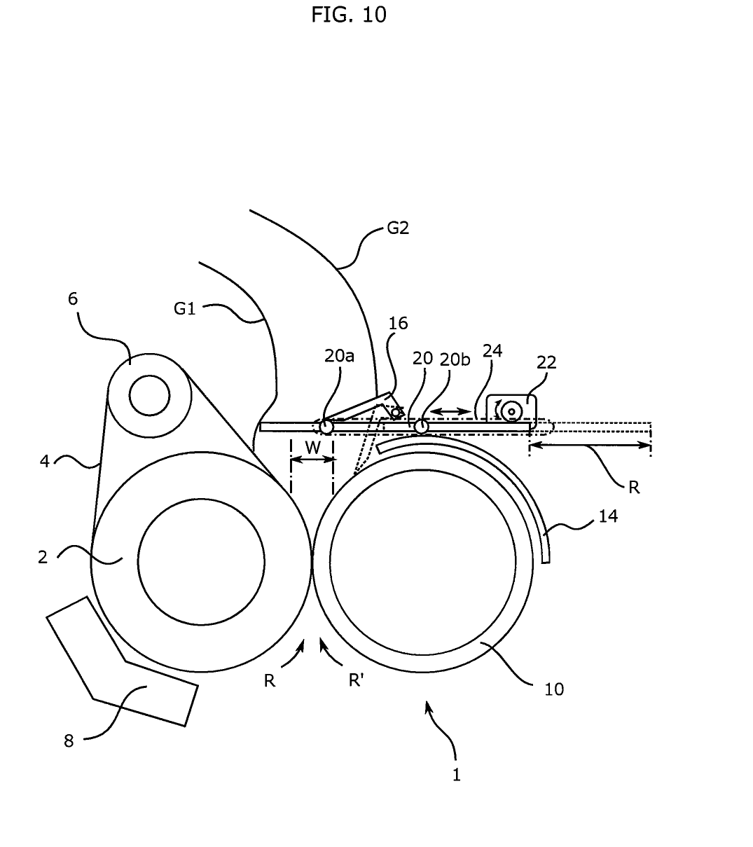

FIG. 10 is a sectional view of the fixing device 1 according to this embodiment. Like the heat accumulating unit 14 according to the first embodiment, the heat accumulating unit 14 is arranged to be fixed to cover the range at an angle equal to or larger than 45 degrees in the direction opposite to the nip N with respect to the vertical direction from the position further on the downstream side in the rotating direction R′ than the contact position of the peeling pawl 16 and the pressing roller 10.

The opening and closing heat accumulating unit 20 that slides in the horizontal direction is arranged above the heat accumulating unit 14. The opening and closing heat accumulating unit 20 includes cam followers 20a and 20b at both the ends thereof. When the cam followers 20a and 20b follow cams 24 formed in the horizontal direction, the opening and closing heat accumulating unit 20 can move in the horizontal direction. The opening and closing heat accumulating unit 20 is moved in the horizontal direction by an opening-and-closing-heat-accumulating-unit driving unit 22.

With the configuration explained above, in the fixing device 1 according to this embodiment, in the standby state in which the fixing processing is not performed, the opening and closing heat accumulating unit 20 can spring up the peeling pawl 16, move to a position where the opening and closing heat accumulating unit 20 comes into contact with the guide surface G1 on the fixing belt 4 side, covers above the pressing roller 10, and block a path above the nip N through which a sheet passes. Consequently, heat emitted from the pressing roller 10 to a sheet path side formed by the guide surface G1 and a guide surface G2 can be accumulated by the opening and closing heat accumulating unit 20. Therefore, a higher heat accumulation effect can be obtained compared with that obtained when the pressing roller 10 is covered by only the heat accumulating unit 14.

When the sheet is nipped and carried to perform the fixing processing, the opening and closing heat accumulating unit 20 retracts to a position indicated by a dotted line according to the driving of the opening-and-closing-heat-accumulating-unit driving unit 22. In FIG. 10, when the position of an end of the opening and closing heat accumulating unit 20 is set as a reference, the opening and closing heat accumulating unit 20 can horizontally move in a range indicated by an arrow R. In the retracted state of the opening and closing heat accumulating unit 20, the opening and closing heat accumulating unit 20 retracts to a position further on the downstream side in the rotating direction R′ than the contact position of the peeling pawl 16 and the pressing roller 10 indicated by the dotted line in FIG. 10.

To move the opening and closing heat accumulating unit 20 to the position reaching the guide surface G1 and the retracted position, the opening and closing heat accumulating unit 20 can be moved by a predetermined distance by using a positioning-controllable driving member such as a stepping motor or by combining a position detecting sensor and a motor. A moving range may be limited by the cams 24.

In the explanation of this embodiment, the peeling pawl 16 is sprung up by the end of the opening and closing heat accumulating unit 20 when the opening and closing heat accumulating unit 20 moves to the guide surface G1. However, the movement of the peeling pawl 16 is not limited to this. For example, a mechanism that moves up and down in association with the operation of the opening and closing heat accumulating unit 20 may be provided or a driving member may be separately provided and moved up and down.

In the explanation of this embodiment, the opening and closing heat accumulating unit 20 horizontally moves. However, the movement of the opening and closing heat accumulating unit 20 is not limited to this. The opening and closing heat accumulating unit 20 may be moved in any direction as long as the opening and closing heat accumulating unit 20 moves to the guide surface G1 and the distal end of the opening and closing heat accumulating unit 20 can come into contact with the guide surface G1 and block the sheet carrying path. The position of the opening and closing heat accumulating unit 20 is not limited by a positional relation between the heat accumulating unit 14 and the peeling pawl 16. However, the opening and closing heat accumulating unit 20 is desirably arranged in a position where a sheet peeled off by the peeling pawl 16 is not caught by the opening and closing heat accumulating unit 20 again.

In the explanation of this embodiment, the opening and closing heat accumulating unit 20 includes the two cam followers 20a and 20b. However, the number of cam followers is not limited to this. The number of cam followers may be any number as long as the opening and closing heat accumulating unit 20 can accurately follow the cams 24.

In the explanation of this embodiment, the opening and closing heat accumulating unit 20 is directly driven by the opening-and-closing-heat-accumulating-unit driving unit 22. However, a driving unit for the opening and closing heat accumulating unit 20 is not limited to this. For example, the driving unit may be any mechanism or member that can slide the opening and closing heat accumulating unit 20 such as a link mechanism.

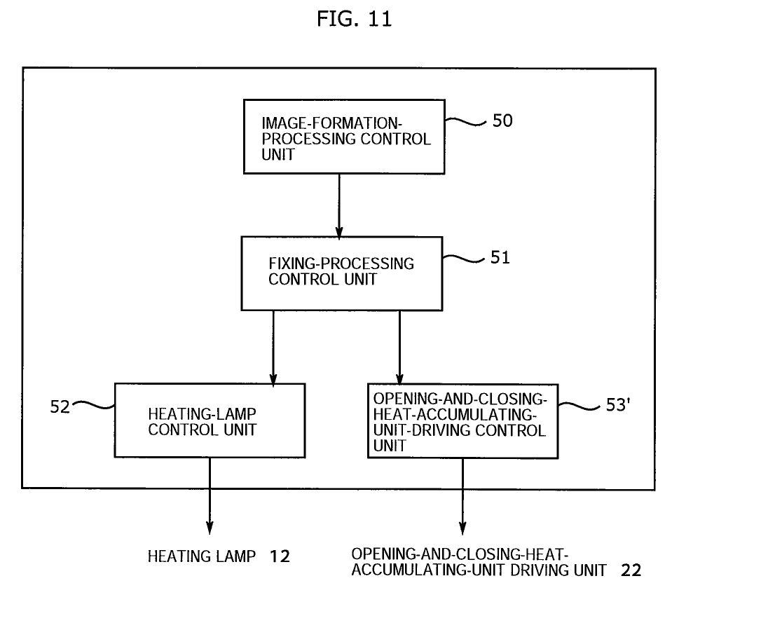

Driving processing for the opening and closing heat accumulating unit 20 is explained with reference to FIG. 11. FIG. 11 is a functional block diagram for explaining the image forming apparatus 100 including the fixing device 1 according to this embodiment.

The image-formation-processing control unit 50, the fixing-processing control unit 51, and the heating-lamp control unit 52 are the same as the functional blocks explained with reference to FIG. 6 in the second embodiment. Therefore, explanation of the units is omitted. An opening-and-closing-heat-accumulating-unit-driving control unit 53′ controls the opening-and-closing-heat-accumulating-unit driving unit 22 that drives the opening and closing heat accumulating unit 20.

In the functional blocks, first, when the fixing device 1 receives an instruction from the image-formation-processing control unit 50 and comes into the standby state, the fixing-processing control unit 51 instructs the heating-lamp control unit 52 to turn off the heating lamp 12. The fixing-processing control unit 51 instructs the opening-and-closing-heat-accumulating-unit-driving control unit 53′ to drive the opening-and-closing-heat-accumulating-unit driving unit 22 and move the opening and closing heat accumulating unit 20 to a predetermined position for blocking the path. The heating-lamp control unit 52 receives the instruction and turns off the heating lamp 12. The opening-and-closing-heat-accumulating-unit-driving control unit 53′ drives the opening-and-closing-heat-accumulating-unit driving unit 22 to move the opening and closing heat accumulating unit 20 to the predetermined position for blocking the path. According to the processing, in the standby state of the fixing device 1, the operation for moving the opening and closing heat accumulating unit 20 to the position for blocking the path and performing heat accumulation is completed.

On the other hand, when processing for retracting, from this state, the opening and closing heat accumulating unit 20 to perform the fixing processing is performed, the fixing-processing control unit 51 instructs the opening-and-closing-heat-accumulating-unit-driving control unit 53′ to retract the opening and closing heat accumulating unit 20 to the predetermined position. The opening-and-closing-heat-accumulating-unit-driving control unit 53′ receives the instruction and drives the opening-and-closing-heat-accumulating-unit-driving unit 22 to move the opening and closing heat accumulating unit 20 to the predetermined position on the inner side of the peeling pawl 16 and retract the opening and closing heat accumulating unit 20. According to the processing, the operation for retracting, from the state in which the opening and closing heat accumulating unit 20 blocks the path and performs heat accumulation, the opening and closing heat accumulating unit 20 to perform the fixing processing is completed.

When the opening-and-closing-heat-accumulating-unit driving unit 22 is a positioning-controllable motor such as a stepping motor, the opening-and-closing-heat-accumulating-unit-driving control unit 53′ can move the heat accumulating unit 14 in a predetermined range by driving the heat-accumulating-unit driving motor 17 by a distance from the position where the opening and closing heat accumulating unit 20 blocks the path to the retracted position stored in the memory 104 in advance.

As explained above, with the fixing device 1 according to this embodiment, the sheet carrying path formed by the guide surface G1 and the guide surface G2 can be blocked by the heat accumulating unit 14 to perform heat accumulation. Therefore, the heat emitted from the pressing roller 10 can be surely accumulated. In this case, heat emitted from the fixing belt 4 to the sheet carrying path side can also be accumulated. Therefore, there is an effect that the heat accumulation effect is higher. Therefore, an excellent heat keeping effect can be obtained. A reduction in warm-up time and saving of energy for warm-up can be realized.

In the embodiments explained above, the heat accumulating unit is arranged on the pressing roller 10. However, the arrangement of the heat accumulating unit is not limited to this. It is also possible to arrange the heat accumulating unit on a fixing roller for melting a toner on a sheet. In the case of the fixing belt type, the heat accumulating unit can also be arranged along an outer circumference of a fixing belt. In both the cases, it is possible to prevent a temperature fall in the standby state and realize a reduction in energy for heating and quick reset to the fixing temperature by accumulating heat of the fixing roller or the fixing belt as the heating rotational unit and keeping the heat. When the heat accumulating unit is arranged in the heating rotational unit, a range in the axial direction of the fixing roller covered by the heat accumulating unit is the range at least larger than the heating range in the axial direction of the fixing roller as explained above.

The present invention can be carried out in other various forms without departing from the spirit or main characteristics thereof. Therefore, the embodiments are merely illustrations in every aspect and should not be limitedly interpreted. The scope of the present invention is indicated by claims and is not restricted by the text of the specification. All modifications and various alterations, replacements, and improvements belonging to the scope of equivalents of claims are within the scope of the present invention.

As explained in detail above, according to the present invention, it is possible to provide a technique for reducing waste of thermal energy in the fixing device.

What is claimed is:

1. A fixing device comprising:
a heating rotational unit configured to heat a sheet on which a toner image is formed;
a pressing rotational unit configured to come into press contact with the heating rotational unit to form a nip between the heating rotational unit and the pressing rotational unit and carry the sheet in cooperation with the heating rotational unit;
a heating device configured to heat the heating rotational unit; and
a heat accumulating unit configured to cover at least an upper portion of at least one of the heating rotational unit and the pressing rotational unit and accumulate at least a part of heat radiated from at least one of the rotational units.

2. The fixing device according to claim 1, wherein the heat accumulating unit includes:
a heat accumulating layer arranged to be opposed to an object, heat of which is accumulated; and
a heat insulating layer arranged on a side of the heat accumulating layer not opposed to the object.

3. The fixing device according to claim 1, wherein the pressing rotational unit is a pressing roller.

4. The fixing device according to claim 3, wherein the heat accumulating unit is formed in a curved surface shape that covers a roller surface in a predetermined angle range around a rotating shaft of the pressing roller along the roller surface.

5. The fixing device according to claim 4, wherein
the heating rotational unit includes a roller that presses at least the pressing roller,
the rotating shaft of the pressing roller is arranged in a height position higher than or substantially the same as a rotating shaft of the roller that presses the pressing roller, and
the heat accumulating unit covers an angle range of the roller surface of the pressing roller from a position above in a vertical direction of the rotating shaft of the pressing roller to a position rotated 45 degrees in a direction opposite to the nip around the rotating shaft of the pressing roller with respect to the vertical direction.

6. The fixing device according to claim 5, wherein the heat accumulating unit covers a range located further on a downstream side in a rotating direction of the pressing roller than a contact position of a peeling member, which is arranged on the downstream side in the rotating direction of the pressing roller with respect to the nip, with the pressing roller.

7. The fixing device according to claim 3, further comprising a pressing-roller heating unit configured to heat the pressing roller, wherein
the heat accumulating unit covers at least a range larger than a heating range heated by the pressing-roller heating unit in an axial direction of the pressing roller.

8. The fixing device according to claim 4, further comprising:
a cam located on at least one end side of the heat accumulating unit in an axial direction of the pressing roller and formed further on an outer side in a radial direction than an outer circumferential surface of the pressing roller; and
a cam follower provided integrally with the heat accumulating unit at least at one end in the axial direction of the heat accumulating unit and movably guided in a predetermined direction by the cam.

9. The fixing device according to claim 8, wherein a moving track of the cam follower guided by the cam is set to be a shape along the roller surface of the pressing roller in a rotating shaft direction view of the pressing roller.

10. The fixing device according to claim 9, further comprising:
a driving unit configured to move the heat accumulating unit in the predetermined direction; and
a driving control unit configured to control the driving unit to cause a part of the heat accumulating unit to enter as deep as a predetermined position in a sheet carrying path.

11. The fixing device according to claim 10, wherein the driving control unit controls the driving unit to cause the heat accumulating unit to enter as deep as the predetermined position in the sheet carrying path when fixing processing is not performed in the fixing device.

12. The fixing device according to claim 11, wherein the driving control unit controls the driving unit to retract the heat accumulating unit from an inside of the sheet carrying path when the fixing processing is performed in the fixing device.

13. The fixing device according to claim 10, wherein
the heating rotational unit includes a roller that presses at least the pressing roller,
the rotating shaft of the pressing roller is arranged in a height position higher than or substantially the same as a rotating shaft of the roller that presses the pressing roller,
the heat accumulating unit is formed in a shape that covers an angle range equal to or larger than 90 degrees of the roller surface of the pressing roller around the rotating shaft of the pressing roller, and
the driving control unit controls the driving unit such that, in a state in which a part of the heat accumulating unit enters as deep as the predetermined position in the sheet carrying path, the heat accumulating unit covers a range from a position rotated 45 degrees, from a position above in a vertical direction of the rotating shaft of the pressing roller, in a direction on the nip side of the roller surface of the pressing roller around the rotating shaft of the pressing roller with respect to the vertical direction to a position rotated 45 degrees, from the position above in the vertical direction of the rotating shaft of the pressing roller, in a direction opposite to the nip around the rotating shaft of the pressing roller with respect to the vertical direction.

14. The fixing device according to claim 10, further comprising a peeling member pressed to be capable of coming into contact with and separating from a position on the roller surface of the pressing roller near a downstream side of the nip in a rotating direction of the pressing roller, wherein
the heat accumulating unit springs up the peeling member and enters as deep as the predetermined position when a part of the heat accumulating unit enters as deep as the predetermined position in the sheet carrying path.

15. The fixing device according to claim 8, further comprising:
a separation driving unit configured to separate at least one of the pressing roller and the heating rotational unit from the other; and
a separation-driving control unit configured to control, when fixing processing in the fixing device is not performed, the separation driving unit to separate the pressing roller and the heating rotational unit.

16. The fixing device according to claim 15, further comprising an interlocking unit configured to move the heat accumulating unit in association with a separating action by the separation driving unit.

17. The fixing device according to claim 15, wherein the heat accumulating unit moves, when a part of the heat accumulating unit enters as deep as a predetermined position in a sheet carrying path, to a position further on an upstream side than a nip position of the pressing roller and the heating unit in a sheet carrying direction.

18. The fixing device according to claim 8, wherein the cam is formed such that, when a part of the heat accumulating unit enters as deep as a predetermined position in a sheet carrying path, the part of the heat accumulating unit comes into contact with a guide surface on a side opposed to the pressing roller in the sheet carrying path.

19. The fixing device according to claim 2, wherein the heat accumulating layer is a metal layer containing aluminum.

20. The fixing device according to claim 2, wherein the heat insulating layer is a layer containing at least one of silicone rubber, carbon resin, and polycarbonate.
